(19) United States
(12) Patent Application Publication
(10) Pub. No.: US 2013/0219719 A1
(43) Pub. Date: Aug. 29, 2013

(54) Fluid injection system

(71) Applicant: David B. Sisk, Brownsboro, AL (US)

(72) Inventor: David B. Sisk, Brownsboro, AL (US)

(21) Appl. No.: 13/694,928

(22) Filed: Jan. 18, 2013

Related U.S. Application Data
(60) Provisional application No. 61/632,959, filed on Feb. 2, 2012.

(51) Int. Cl. F02K 9/97

(52) U.S. Cl. CPC F02K 9/97
USPC 29/890.1

(57) ABSTRACT

A Fluid Injection System for rocket engines is disclosed, which comprises methods and apparatus for combining a ring-type rocket injector body and face into a single cast part, eliminating all subassemblies, their associated fabrication and integration costs, and thereby significantly lowering injector costs while increasing injector quality and reliability. The injectors may be used in rocket engines and auxiliary propulsion devices such as gas generators for a variety of applications including rockets, missiles, space launch vehicles, space vehicles, and Lunar, asteroid, and Mars lander vehicles.

### FEDERALLY SPONSORED RESEARCH OR DEVELOPMENT

The Inventor developed some of the Inventions described in the Present Non-Provisional Patent Application under two Contracts with Air Force Research Laboratory, Contract No. F29601-02-C-0010 and Contract No. FA9453-08-C-0171.

### CROSS-REFERENCE TO RELATED PATENT APPLICATIONS & CLAIMS FOR PRIORITY

The Present Non-Provisional Patent Application is related to Pending Provisional Patent Application U.S. Ser. No. 61/632,959, filed on 2 Feb. 2012. The Inventor and the Applicant hereby claim the benefit of priority for all subject matter disclosed in U.S. Ser. No. 61/632,959.

### FIELD OF THE INVENTION

The present invention pertains to methods and apparatus for an injection and mixing device for rocket engines. More particularly, the invention comprises a method for combining a ring-type rocket injector body and face into a single cast part, eliminating all or nearly all subassemblies, their associated fabrication and integration costs, and thereby significantly lowering injector costs while increasing injector quality and reliability.

### BACKGROUND OF THE INVENTION

Current art rocket engine injector manufacturing is very time consuming and expensive. Conventional injectors are handcrafted by highly skilled and highly paid craftsmen, and their manufacture generally requires a large number of fabrication steps, extremely close tolerances, extensive brazing or welding, and a great deal of inspection, testing, and rework to ensure high quality.

Most conventional rocket engines comprise a multi-piece injector built-up from an injector body machined and drilled out of a single piece of wrought metal, usually steel or Inconel. The injector face is generally constructed out of individual metal concentric rings with predrilled orifices that are brazed or welded onto the body. This results in a large number of joints that require an extensive amount of manual fit-up to assure the close tolerances necessary for a sound braze joint. It also results in extensive quality control inspection and testing at great expense.

In some cases, the injector face requires further machining after the brazing process to remove excess brazing material and ensure a uniform flat surface. This machining may cause some metal smearing or movement of metal into orifices, which can cause misdirection of the orifice streams or reduced orifice flow rates, and thus poor mixing and non-uniform combustion. In such cases, the orifices often have to be hand reamed and inspected after face machining. Electrical discharge machining (EDM) may have an advantage over mechanical machining in reducing metal smearing.

Injector manufacturing sometimes requires the fabrication of temporary passages through portions of the injector to provide accessibility for further machining. After the machining process is complete, these passages are blocked using closeout plugs. Use of closeout plugs is not ideal as they can leak, causing burnout areas in the injector.

To protect from the high face heating and chemical erosion, some injectors employ refractory coatings, particularly on the face and nearby areas of the injector exposed to the combustion products. Mechanically drilling orifices in injector faces that have already been coated is difficult, because the refractory coatings are generally very hard and abrasive, and can result in deformed orifice exits and thus poor mixing and combustion. Applying refractory coatings to injectors after the orifices have been drilled frequently causes problems such as the movement of the coating material into orifices, which can misdirect the orifice streams or reduce orifice flow rates, and thus contribute to poor mixing and combustion. Attempts to protect the pre-drilled orifices during the coating process such as inserting temporary plugs or other masking techniques have often proven unsatisfactory.

The drilling of the hundreds to thousands of orifices is usually accomplished today using CNC mechanical drill presses. However, injector orifices can also be formed by non-mechanical means via EDM, electrochemical machining (ECM), or laser drilling. Laser drilling is a precise, durable, and often autonomous method for rapidly drilling holes with high precision in a wide range of materials, including hardened and coated aerospace alloys. It is commonly used in the automotive and aerospace industries, and notably in the latter to drill a large number of closely spaced, small diameter cooling holes for turbine engine blades. Laser drilling has many advantages over mechanical drilling. In many cases, laser drilling can be several orders of magnitude faster than mechanical drilling. Since laser drilling is non-contact, it excels at drilling holes in hardened and difficult-to-machine materials without excessive wearing or breakage of conventional machining tools. Laser drilling can far more easily accommodate drilling at shallow surface angles than mechanical machining, and precise results are easily reproduced. Laser drilling also has several advantages over EDM drilling in that it is generally much faster, can produce smaller holes, and can be used on non-conducting substrates or metallic substrates coated with non-conducting materials such as thermal barrier-coated alloys in aerospace applications. EDM and ECM processes have been successfully used in the past to drill rocket engine injector orifices for the cases where both sides of the orifices are completely accessible but have often been unsuccessful with “blind inlets,” in which there is no direct physical access to the inlet side of the orifice.

Regardless of the method to drill the injector orifices, quality is critically important. Among other factors, orifice geometric spacing, inlet geometry, exit contour, bore roughness and geometry, and related tolerances all impact reproducibility and overall injector performance. Examples of orifice-derived injector problems include detachment of the flow from the orifice wall that increases injector pressure drop and lowers overall engine thrust, combustion chamber wall overheating due to orifice inlet or outlet burrs in the outer rings, and large variations in injector pressure drop due to variations in orifice inlet geometries. Such problems can lead to injector failures and rocket engine operational problems. These problems can be particularly challenging in situations where the orifices have blind inlets, such as the case of when orifices are drilled after the injector rings are welded or brazed into the injector body. Abrasive flow machining, in which an abrasive substance is incorporated into a polymer or other fluid that is forced under pressure through the injector to smooth and polish propellant passages and orifices, can be particularly useful under these circumstances.

Due to the high number of human-touch labor hours required to properly fit the components of an injector prior to brazing or welding and the possible catastrophic consequence of mistakes, quality control is extremely important in rocket injector manufacturing. It can be difficult, sometimes impossible, to thoroughly test the soundness or integrity of the joints, particularly to determine if there is leakage between the fuel and oxidizer propellants. Ultrasonic testing, X-ray testing, computed tomography (CT), and other non-destructive examination techniques are employed. Leakage in the injector can lead to premature mixing of the propellants and often result in extensive damage or destruction of the injector, which in turn can lead to damage or destruction of the engine or entire rocket. Precise orifice placement is critical to the proper functioning of the injector as errors can cause combustion instability and extreme localized heating in certain areas of the combustion chamber, such as thrust chamber streaking or injector face erosion, which can damage or even destroy the chamber, engine, or even the entire rocket.

Injector failures can lead to propulsion system and launch mission failures. In April 1968, the Apollo 6 Saturn V third-stage J-2 engine failed to restart for a simulated translunar injection because of a fuel-injector burn-through. Brazing, commonly used to manufacture ring-type injectors, is still largely an art and represents a mode of failure not uncommon in rocket engines. A May 1999 Delta 3 rocket, for example, had a catastrophic in-flight failure due to the failure of a braze in the combustion chamber of the RL 10B-2 upper stage engine. A February 1998 Japanese H-II rocket launch was destroyed because of a combustion chamber braze failure in the second firing of the second stage LE-5A engine. The uncertainties and subjectivity of conventional manufacturing methods such as brazing and welding of current art injectors require multiple injector manufacturing, inspection, testing, and rework cycles, contributing to both lengthy injector manufacturing times and high manufacturing costs.

An integral face, where the face is a single piece, is generally not possible for ring-type injectors due to the difficulty in attaching the face to the injector body's propellant racetrack edges without leaks that could lead to injector burnout and engine or mission failure. Brazing techniques to join a single piece face with the injector body, such as vacuum brazing in a furnace, have been applied but with limited success. A NASA report on liquid rocket engine injector design (NASA SP-8089, NASA Space Vehicle Design Criteria—Liquid. Rocket Engine Injectors) notes that face casting has not been developed for a production injector for any material other than aluminum, a material that is generally suited only for hypergolic propellants and not the cryogenic propellants used in most space launch rockets. Injector bodies and faces for space launch rockets using cryogenic propellants are generally made of stainless steel, nickel, or nickel alloys such as Inconel, although copper was used for the injector faces on some older engines because of its high thermal conductivity.

Current art rocket engine injectors are generally very expensive. As part of the mid-1990s FASTRAC rocket engine development program, NASA noted that an injector for a mid-sized space launch rocket engine can cost $200,000 to $300,000. Other sources note that rocket engine injectors can cost $50,000 to $100,000 for even modest sized space launch rocket engines. Since current art space launch vehicles today are only launched at most a handful of times a year and these rockets generally all use unique injector designs, rocket engine injector production rates are extremely low. These negligible economies of scale further contribute to extremely high, current art, rocket engine injector manufacturing costs. Regardless, spending $50,000 to $300,000 per injector to produce a handful of injectors in a year is often considered an almost negligible cost, at least relative to the cost of a space launch, which can exceed hundreds of millions of dollars per flight. For planned, future, very low cost space launch systems with designs employing a large number of rocket engines, however, there are relatively high economies of scale and lowering injector manufacturing costs is critical. Embodiments of the present invention are particularly well-suited, for example, for segmented or otherwise mass producible launch systems, such as those disclosed by Sisk, U.S. Pat. No. 6,036,144.

Investment casting, one of the oldest metal casting techniques, is currently used today to produce complicated-shape metallic products having very good surface finish for minimal machining at high production rates. The investment casting process begins with the production of a heat-disposable pattern. This is usually accomplished by injection molding special waxes into a metal die to form a wax pattern but other means exist such as using stereolithography to create a pattern out of wax or resins. Ceramic cores can be included in the wax pattern to form interior, complex, hollow volumes in the finished casting. Alternatively, a ceramic slurry can be inserted into the pattern and allowed or caused to harden to form these interior hollow volumes. The assembly of patterns and cores are then gated, where a pour cup is attached and, especially for smaller parts, a number of patterns may be assembled into a “tree” around a wax runner system. The wax pattern or tree is then dipped, or invested, in ceramic slurry, and coated with fine, special sand, often in a fluidized bed, and allowed to dry. This process is repeated several times to build up a ceramic shell, usually using progressively coarser grades of ceramic material, until the shell is of the proper thickness to handle the molten metal. After the shell has been completely built-up, the wax is removed in an autoclave or furnace and the shell is fired in a kiln. Molten metal is then poured into the shell using one of several different casting methods (e.g. vacuum casting, counter gravity casting, tilt casting, gravity pouring, pressure assisted pouring, centrifugal casting). After the parts cool, the shell is removed, and any excess metal detached.

If ceramic cores were used, that material is removed by chemically dissolving it. Various processes can be used to increase the speed of chemically removing the ceramic cores such as cryogenically shocking the investment cast injector, mechanically shaking or vibrating it, or subjecting it to ultrasonics, in order to crack or make passages within the ceramic cores for the chemicals to propagate. The ceramic cores can also sometimes be removed by other mechanical means such as drilling.

The parts are then stress relieved, machined, finished, tested, and cleaned, as needed. In some cases, refractory coatings may be added to the face or other areas of the injector.

The investment casting process is very difficult to apply to such a complex shape as a single-piece injector body and face. As noted above, orifice quality control is severely challenged by mechanical drilling of the orifices, which generally leaves burrs and residual metallic bits that can disrupt the propellant flow through the orifices, and orifice inlet quality control is even more difficult with blind inlets, which are a result of a single piece injector face and body combination.

Investment casting is commonly used to manufacture metallic aerospace components such as single crystal turbine blades for aircraft jet engines. However, while castings are sometimes used to form a blank that is machined to create current art rocket injector bodies, literature searches turned up no evidence of the investment casting process used to make rocket engine injectors.

Ring-type rocket engine injectors for even modest sized space launch rocket engines today can cost $50,000 to $300,000 to manufacture, take a long time to fabricate, and require extensive testing and rework to ensure adequate quality. To reduce the cost of spacelift, especially for future systems that may employ a large number of rocket engines and thus have very high economies of scale and employ high rate production, lowering injector manufacturing costs and reducing fabrication times are critical. Needed is a method to lower the cost of manufacturing rocket engine ring-type injectors by an order of magnitude, while reducing fabrication and rework effort and time and maintaining at least as high quality and reliability as that of current art injectors.

The development of a low-cost, yet highly reliable system and apparatus for manufacturing fluid injection devices for rocket engines would constitute a major technical advance, and would satisfy long-felt needs in the aerospace industry.

### SUMMARY OF THE INVENTION

The present invention comprises methods for manufacturing a lower cost, highly reliable, fluid injection device for rocket engines. More particularly, the invention comprises a method for combining a ring-type rocket injector body and face into a single cast part, and eliminating all major subassemblies, their associated fabrication and integration costs, thereby increasing injector quality and reliability. Various methods of investment casting are employed to manufacture the rocket engine injector, including creating heat disposable patterns by injection molding special waxes into a die to form a wax pattern or using stereolithography to create a pattern out of wax or resins, and employing ceramic cores or other means to create the racetracks and the injector manifolds.

The present invention combines the face and body of a rocket engine ring-type injector, with large numbers of concentric rings and orifices, into a single part. One embodiment of the invention greatly reduces the number of component parts and the use of subjective, human labor-intensive processes such as brazing, welding, mechanical drilling, and extensive testing and rework to manufacture injectors, which leads to higher quality and reliability and lower costs. The invention eliminates the multi-ring brazed interfaces, which in some cases comprise eight or more individual joints, reduces risk of inter-racetrack propellant mixing, and eliminates the need for tooling to size and straighten the racetracks to accommodate the injector face. The present invention greatly lowers the cost of manufacturing rocket engine ring-type injectors, while maintaining at least as high quality and reliability as that of current art injectors. Several embodiments of the invention are suitable for high rate rocket engine production and takes advantage of relatively large manufacturing economies of scale. The invention applies to rocket engines and auxiliary propulsion devices such as gas generators utilizing their liquid propellants in either liquid or gaseous form, and to either monopropellants, bipropellants, or tripropellants.

One preferred embodiment of the invention employs pre-formed ceramic cores to form the racetracks, the injector manifolds, and other volumes in the investment casting process and later chemically removing them. The ceramic cores can be created via a variety of means including injection molding and fabricating via automated printing-like processes directly from CAD tools.

Another embodiment of the invention utilizes the insertion of a ceramic slurry into the pattern and allowing or causing it to harden to create ceramic cores before casting the injector to form the racetracks, the injector manifolds, and other volumes in the investment casting process. The ceramic cores are then chemically removed after the casting, typically by dissolving them with a caustic solution.

Various processes can be used to increase the speed of chemically removing the ceramic cores, such as cryogenically shocking the investment cast injector, mechanically shaking or vibrating it, or subjecting it to ultrasonics, in order to crack or make passages within the ceramic cores for the chemicals to propagate. The ceramic cores can also be removed by mechanical means such as drilling.

Another embodiment of the invention employs heat-disposable, resin-based polymeric patterns instead or in addition to wax patterns in the investment casting process. The resin-based polymeric patterns can be created via a variety of means including stereolithography or other automated printing-like processes directly from CAD tools.

Another embodiment of the invention uses non-mechanical means such as laser drilling or EDM to manufacture the injector orifices.

Another embodiment uses abrasive flow machining to smooth and polish injector passages and orifices.

An appreciation of the other aims and objectives of the present invention, and a more complete and comprehensive understanding of this invention, may be obtained by studying the following description of preferred and alternative embodiments, and referring to the accompanying drawings.

### A BRIEF DESCRIPTION OF THE DRAWINGS

FIG. 1 is an illustration of a conventional space launch vehicle or missile employing a rocket engine.

FIG. 2 is a cut-away view of a conventional rocket engine incorporating a ring-type injector.

FIG. 3 is a cut-away view of a conventional rocket engine incorporating a ring-type injector with the injector body and face combined into a single cast part.

FIG. 4 presents a flow chart that illustrates the conventional, current art method for manufacturing rocket engine ring-type injectors.

FIG. 5 depicts a flow chart that illustrates the well-known, generalized method of investment casting.

FIG. 6 presents a flow chart that illustrates a second generalized method of investment casting that uses patterns and interior volume shelling or filling.

FIG. 7 shows a flow chart showing a well-known generalized method to remove the cores from the inside of the casting.

FIG. 8 presents a flow chart that depicts a first generalized method of the present invention method for manufacturing rocket engine ring-type injectors.

FIG. 9 shows a flow chart that depicts a second generalized method of the present invention method for manufacturing rocket engine ring-type injectors.

### A DETAILED DESCRIPTION OF PREFERRED & ALTERNATIVE EMBODIMENTS

### I. Overview of the Invention

The present invention comprises methods for combining the body and face of a ring-type rocket injector into a single cast part, thereby eliminating the major subassemblies of the face, their associated fabrication and integration costs, and increasing injector quality and reliability. Various methods of investment casting are employed to manufacture the rocket engine injector, including creating heat disposable patterns by injection molding special waxes into a die to form a wax pattern or using stereolithography to create a pattern out of resins, and employing ceramic cores or other means to create the racetracks and the injector manifolds.

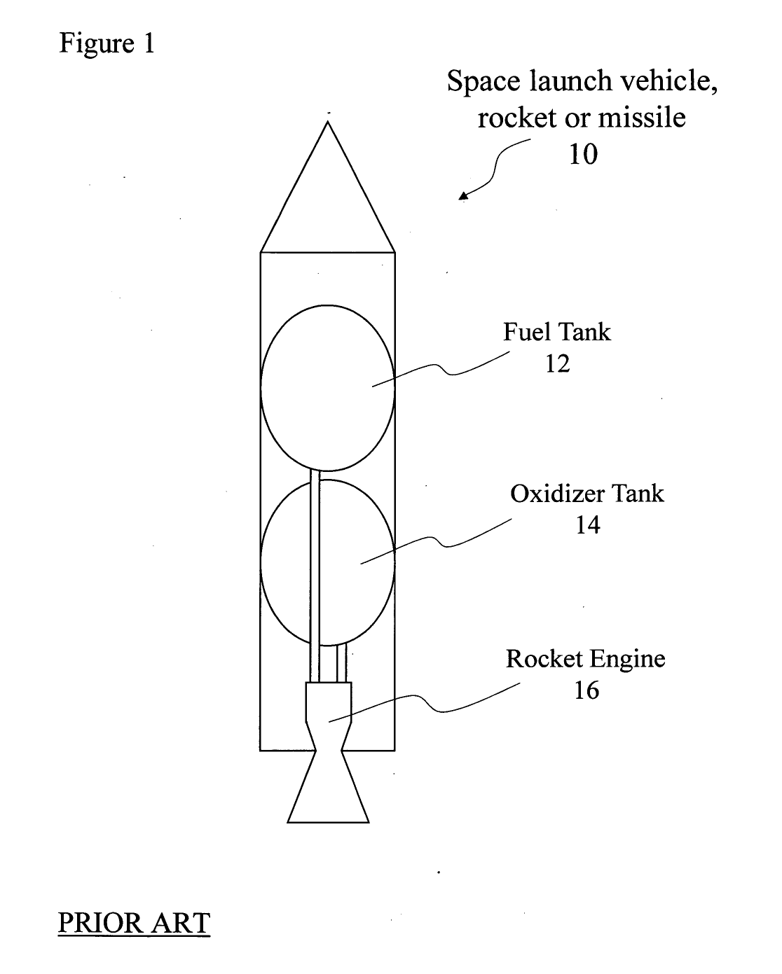

FIG. 1 depicts a cut-away view of a space launch vehicle, rocket, or missile 10, showing a fuel tank 12, an oxidizer tank 14, and rocket engine 16.

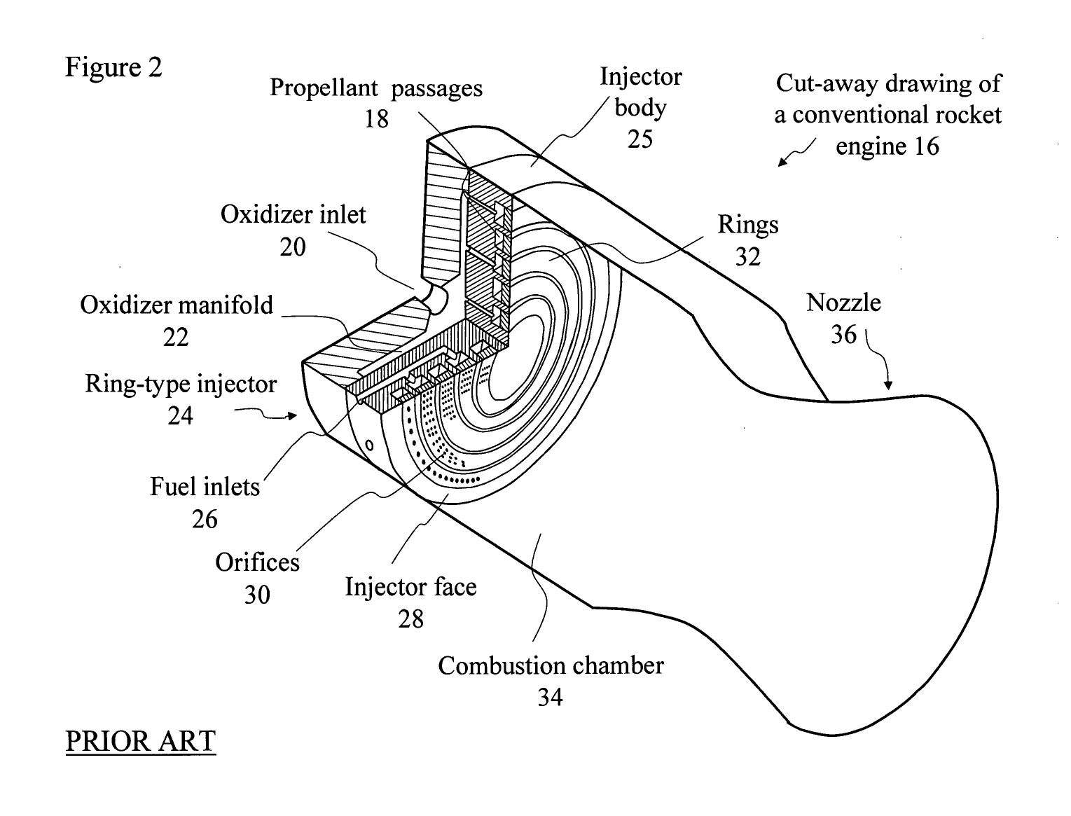

FIG. 2 shows a cut-away drawing of a conventional rocket engine 16 that employs a typical ring-type injector 24. While this drawing depicts a typical ring-type injector, those well versed in the art understand many ring-type injector variations exist with significantly different geometries. In general, however, bipropellant ring-type injectors will all have some type of oxidizer inlet 20, oxidizer manifold 22, fuel inlets 26, and injector face 28. The rings 32 of the injector face 28 typically have hundreds to a few thousand orifices 30. The rocket engine 16 includes a combustion chamber 34 and nozzle 36, as well as a number of other components not depicted here, such as rocket engine igniters, propellant manifolds, turbopumps, sensors, etc.

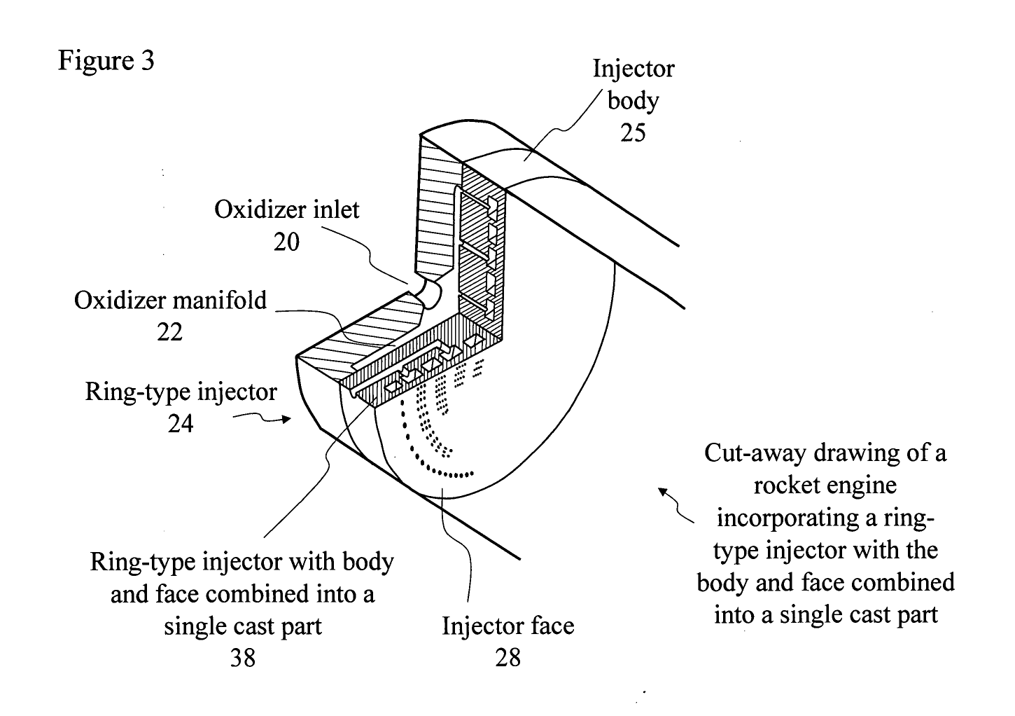

FIG. 3 is a cut-away view of a conventional rocket engine incorporating the result of the current invention, a ring-type injector with the injector body and face combined into a single cast part.

While FIGS. 1, 2 and 3 depict bipropellant rocket engines, which are conventional for space launch vehicles, those well versed in the art understand many variations exist. The present invention applies to injectors that can be used for rocket engines and auxiliary propulsion devices such as gas generators that use gas or liquid monopropellants, bipropellants, or tripropellants.

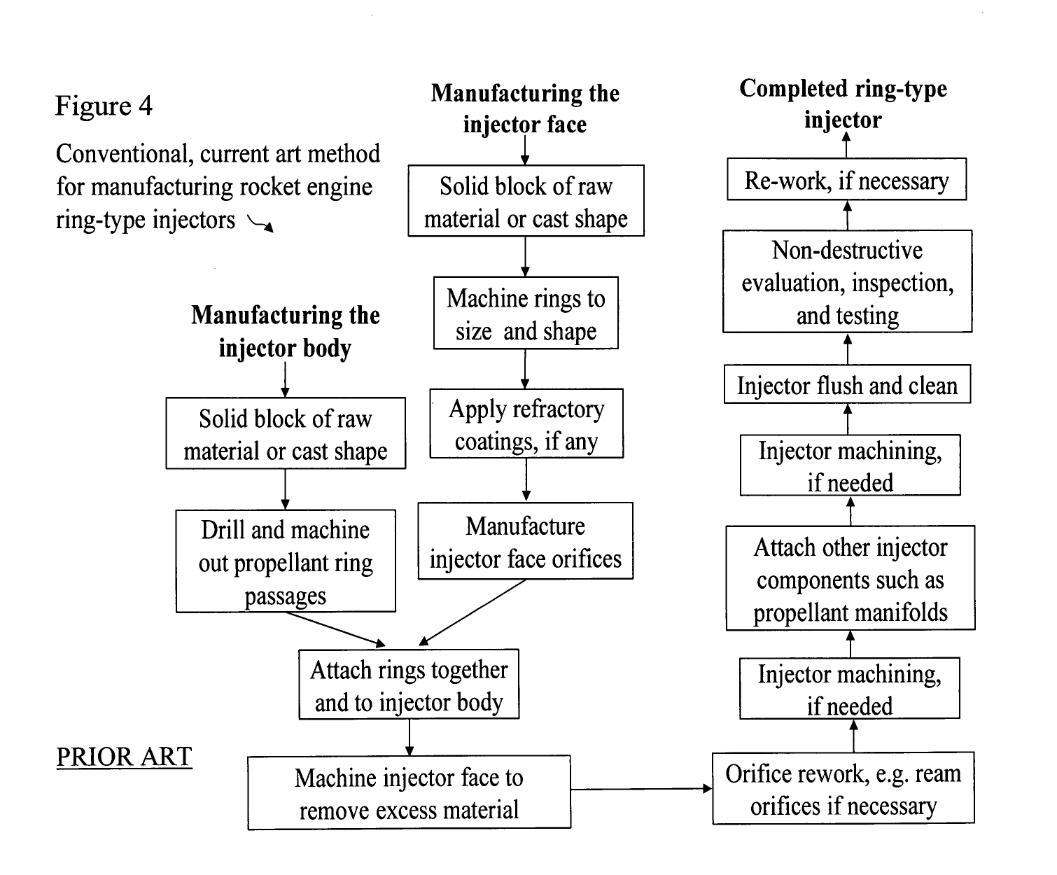

FIG. 4 is a flow chart depicting the conventional current art method for manufacturing a ring-type rocket engine injector 24. The method employs manufacturing the injector body 25 separately from manufacturing the injector face 28 and then later combining them. The method to manufacture the injector body begins with a solid block of raw material or a roughly cast shape, usually composed of Inconel or stainless steel. This material is generally drilled and machined to form the injector body shape and to create the propellant ring passages. The method to manufacture the injector face begins with a solid block or blocks of raw material or roughly cast shapes, usually composed of Inconel or stainless steel. This material is machined to form the rings 32, and refractory coatings, if used, are usually then applied, followed by the manufacturing of the injector face orifices 30. Sometimes the drilling is accomplished before a refractory coating is applied.

The injector body 25 and injector face rings 32 are then attached to one another, generally by brazing and/or welding the rings together and to the injector body 25. The injector face 28 is next machined to remove excess material and any necessary orifice rework, such as reaming out the orifices, is conducted. Usually additional injector machining is required, such as drilling attachment passages or adding volumes for sensors or engine igniters. Next, other injector components are then attached such as the sensors, igniters, and propellant manifolds, the latter generally through brazing or welding. Sometimes additional injector machining is required to remove excess brazing or welding material or for other purposes. The injector is flushed and cleaned and inspected and tested to ensure adequate quality and no leakage. Non-destructive evaluation tools such as X-ray or CT scanning machines are frequently employed at this stage. Quality problems generally result in rework.

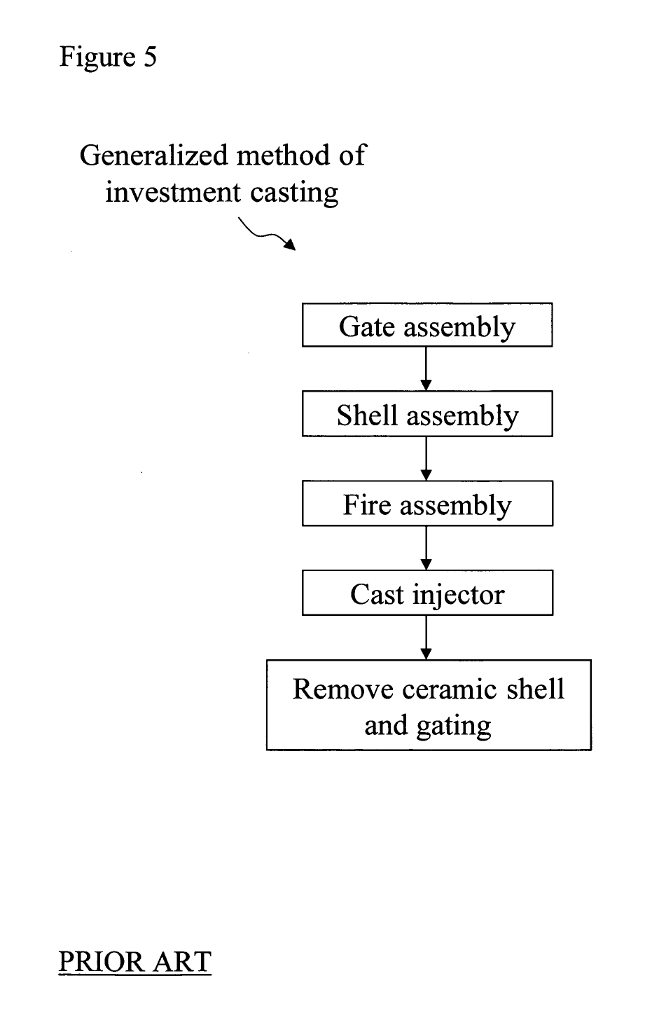

FIG. 5 presents a flow chart that illustrates a well-known generalized method of investment casting. The assembly containing the heat disposable patterns is first gated and then shelled. The assembly is then fired to remove the heat disposable patterns and to harden the ceramic shell. The injector is then cast by pouring in molten metal. After cooling the ceramic shell and gating is removed.

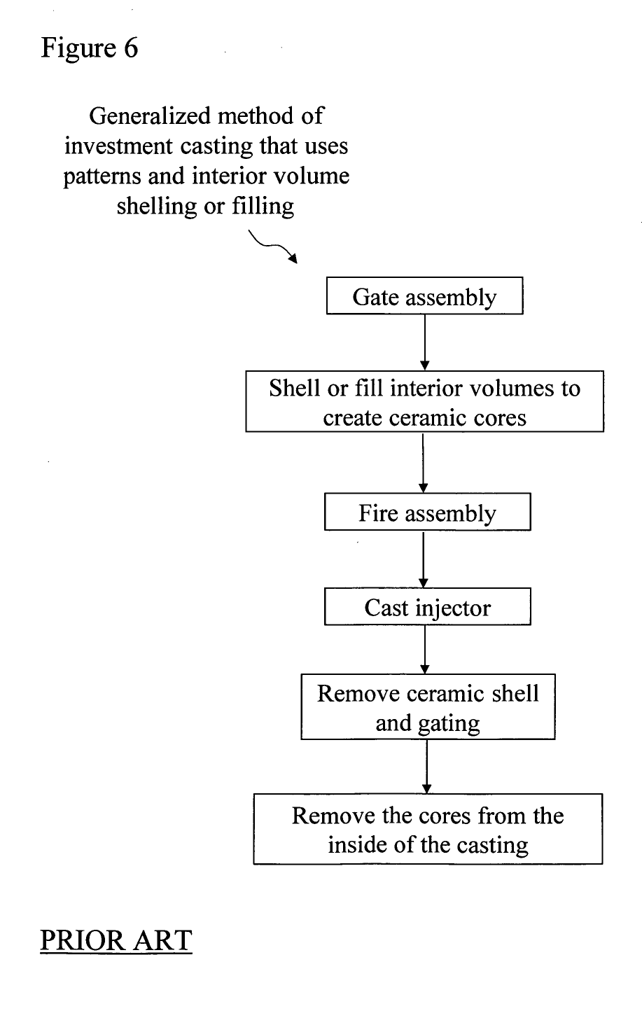

FIG. 6 presents a flow chart that illustrates a well-known generalized method of investment casting that uses patterns and interior volume shelling or filling. The assembly containing the heat disposable patterns is first gated and then shelled. Interior volumes are either shelled at the same time as the entire assembly or are done separately. Shelling of the assembly and interior volumes may take multiple insertions of a ceramic slurry or it may be accomplished by a single insertion of a special formulated ceramic slurry mixture. The cores are then allowed or caused to dry, sometimes as part of the shelling firing. The assembly is then fired to remove the heat disposable patterns and to harden the ceramic shell. The injector is then cast by pouring in molten metal. After cooling, the ceramic shell and gating is removed and the cores are removed from the inside of the casting.

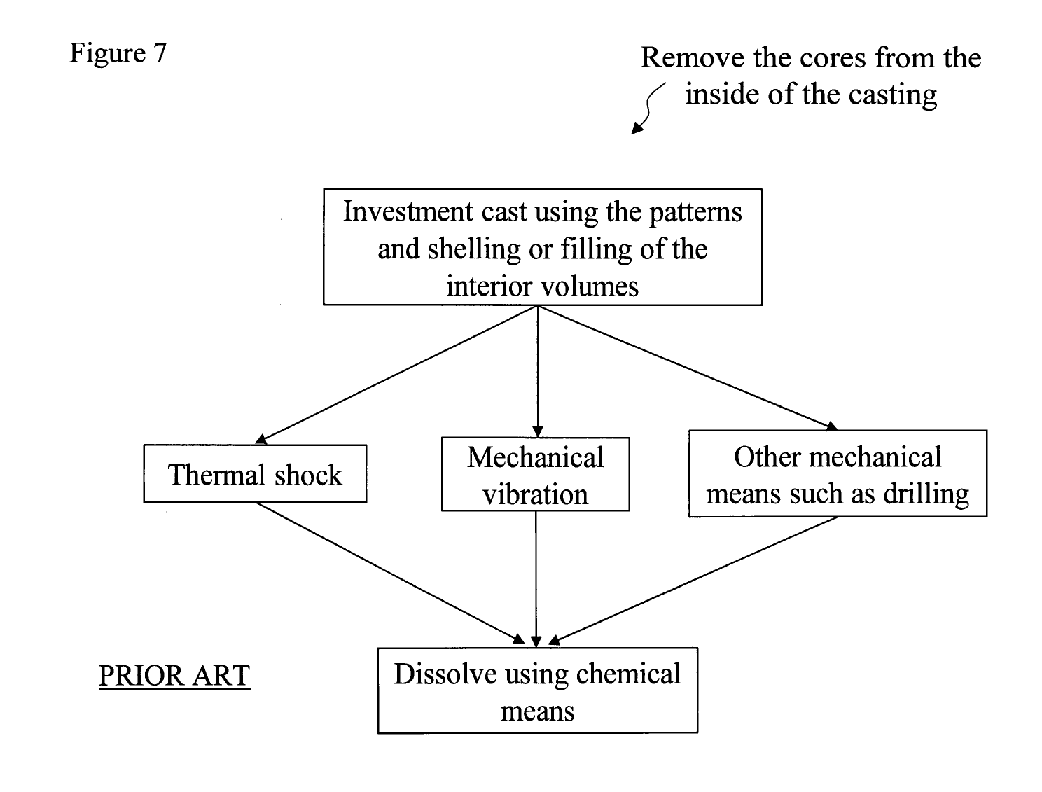

FIG. 7 is a flow chart showing a well-known generalized method to remove the cores from the inside of the investment casting. After investment casting using the patterns and shelling or filling of the interior volumes, the next step is to remove the cores from the casting, generally using a chemical agent to dissolve the cores. Chemical removal of the cores may be facilitated by first subjecting the entire casting to thermal shock or mechanical vibration or other mechanical means, such as drilling, or a combination thereof.

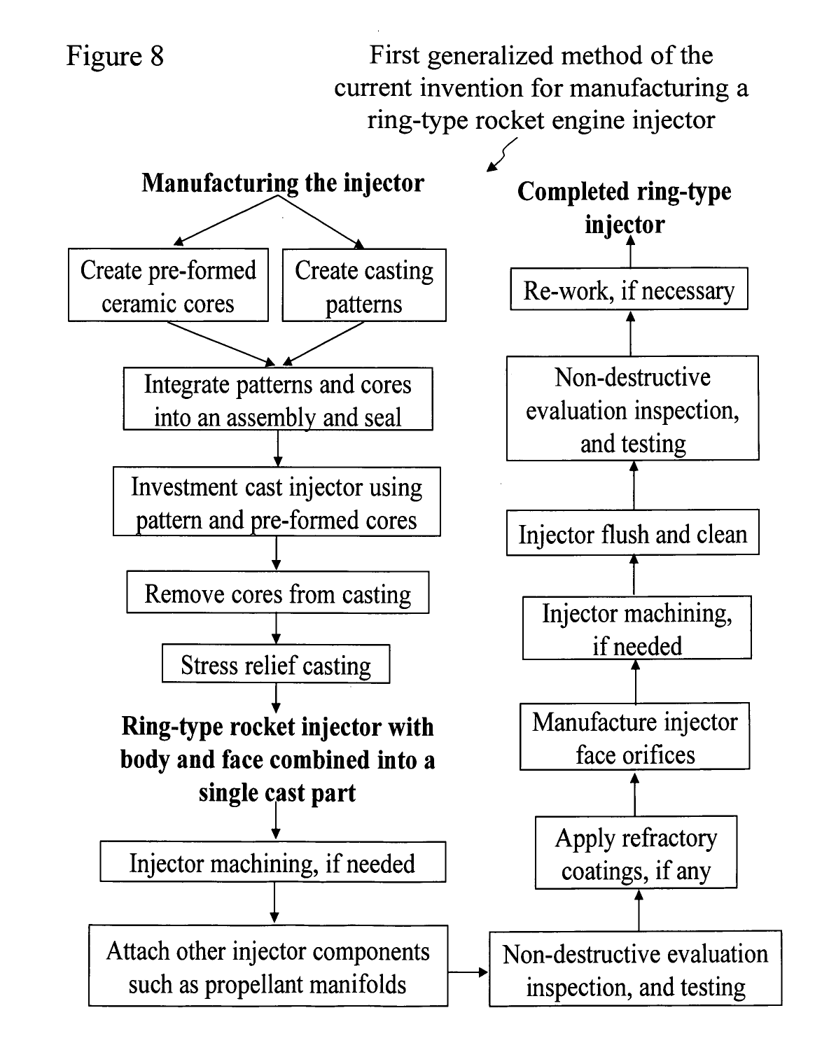

FIG. 8 is a flow chart showing the first method of the current invention for manufacturing a ring-type rocket engine injector with the body and face combined into a single cast part 38. Instead of separately manufacturing the injector body and injector face rings as is done under the method of typical current art, these components are combined into a single unit. In the method of the current invention, the first steps are to create pre-formed ceramic cores and create casting patterns. The cores are in the form of the racetracks and other interior volumes, such as the injector manifolds, and are integrated into the patterns and sealed. Using this assembly, the injector is then investment cast using an appropriate material such as Inconel or stainless steel. The next step in this method is to remove the cores from the casting, generally using a chemical agent to dissolve the cores although thermal shock or mechanical vibration or other mechanical means, such as drilling, or a combination thereof may be also used.

After the cores are removed, the casting is stress relieved by conventional treatment such as heating or vibration. The result is a ring-type rocket injector with the body and face combined into a single cast part 38 that can then be finished using present art injector manufacturing methods. The injector is then machined and other injector components are attached. Next, the injector is proof tested, a type of non-destructive evaluation inspection, and testing, and after proof testing refractory coatings, if used, are applied. Following this step, the injector orifices are manufactured. Sometimes additional injector machining is required such as to remove excess brazing or welding material or to smooth and polish propellant passages 18 and orifices 30 using abrasive flow machining. The injector is then flushed and cleaned and inspected and tested to ensure adequate quality and no leakage. Non-destructive evaluation tools such as X-ray or CT scanning machines are frequently employed at this stage. Any quality problems are generally addressed with rework.

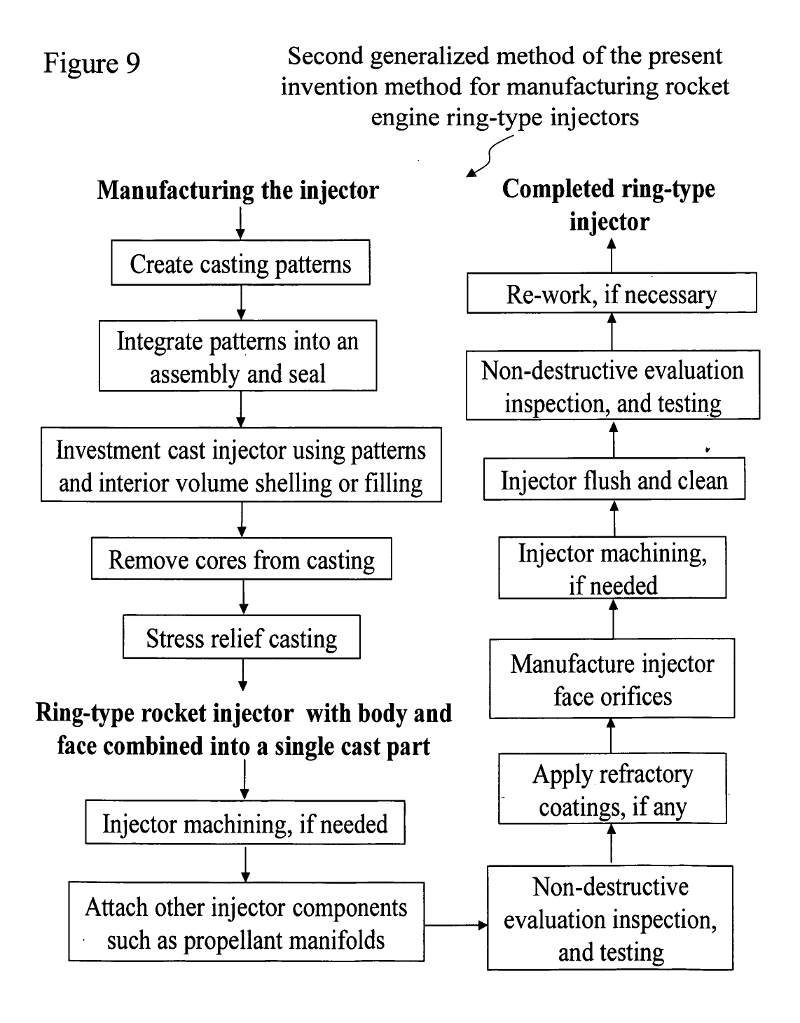

FIG. 9 is a flow chart showing a second generalized method of the current invention for manufacturing a ring-type rocket engine injector. Instead of manufacturing pre-formed ceramic cores, the ceramic cores are made during the investment casting process by inserting a ceramic fill or slurry into the casting pattern. In this method, first casting patterns are created. The patterns are then integrated into an assembly and sealed. The injector is then investment cast using the patterns and shelling or filling of the interior volumes using an appropriate material such as Inconel or stainless steel. The next step in this method is to remove the cores from the casting, generally using a chemical agent to dissolve the cores. Chemical removal of the cores may be facilitated by first subjecting the entire casting to thermal shock or mechanical vibration or other mechanical means, such as drilling, or a combination thereof. The injector is then stress relieved by conventional treatment such as heating or vibration. The result is a ring-type rocket injector with the body and face combined into a single cast part 38 that can then be finished using present art injector manufacturing methods. The injector is then machined and other injector components are attached. The injector is then proof tested, a type of non-destructive evaluation inspection, and testing, and after proof testing other injector components are attached. The injector is then proof tested. Following proof testing, refractory coatings, if used, are applied. Following this step, the injector face orifices are manufactured. Sometimes additional injector machining is required such as to remove excess brazing or welding material or to smooth and polish propellant passages 18 and orifices 30 using abrasive flow machining. The injector is then flushed and cleaned and inspected and tested to ensure adequate quality and no leakage. Non-destructive evaluation tools such as X-ray or CT scanning machines are frequently employed at this stage. Any quality problems are generally addressed with rework.

### II. Preferred & Alternative Embodiments of the Invention

One preferred embodiment of the invention is to employ ceramic cores to form the racetracks and possibly other interior spaces within the injector such as the injector manifolds in the investment casting process and later chemically removing them. The ceramic cores can be created via a variety of means including injection molding and fabricating via automated printing-like processes directly from CAD (Computer Aided Design) tools.

Another embodiment of the invention is to employ heat-disposable, resin-based polymeric patterns instead or in addition to traditional wax patterns in the investment casting processes. Resin-based composite patterns can be created via a variety of means including stereolithography or other automated printing-like processes directly from CAD tools.

Another embodiment of the invention is to use non-mechanical means such as laser drilling or Electrical Discharge Machining (EDM) to manufacture the injector face orifices 30.

Another embodiment uses abrasive flow machining to smooth and polish propellant passages 18 and orifices 30 after drilling the injector face orifices and before or after attaching the other injector components such as propellant manifolds.

Another embodiment is to change the sequence of some of the steps in the flow chart showing the method of the current invention for manufacturing a ring-type rocket engine injector to meet specific injector needs. For example, in some cases the step of attaching other injector components such as propellant manifolds might be more advantageously accomplished after the step of applying refractory coatings.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the Claims that follow. The various alternatives for providing a Fluid Injection System that have been disclosed above are intended to educate the reader about preferred embodiments of the invention, and are not intended to constrain the limits of the invention or the scope of Claims.

### LIST OF REFERENCE CHARACTERS

10 Space launch vehicle, rocket, or missile
12 Fuel tank
14 Oxidizer tank
16 Rocket engine
18 Propellant passages
20 Oxidizer inlet
22 Oxidizer manifold
24 Ring-type injector
25 Injector body
26 Fuel inlets
28 Injector face
30 Orifice
32 Rings
34 Combustion chamber
36 Nozzle
38 Ring-type rocket injector with the body and face combined into a single cast part

What is claimed is:

1. A method comprising the steps of:
creating a casting pattern and a pre-formed ceramic core for a ring-type rocket engine injector (24);
integrating said casting pattern and said pre-formed ceramic core into an assembly;
sealing said assembly;
investment casting said assembly;
removing said core from said casting;
stress relieving said casting; and
producing a ring-type rocket injector with a body and a face combined into a single cast part (38).

2. A method comprising the steps of:
creating a casting pattern for a ring-type rocket engine injector (24);
integrating said casting pattern into an assembly;
sealing said assembly;
investment casting said assembly using said casting pattern and an interior volume filling;
removing a core from said casting; and
stress relieving said casting;
producing a ring-type rocket injector with a body and a face combined into a single cast part (38).

3. A method as recited in claim 2, in which:
said interior volume filling is done by shelling during an investment casting process.

4. A method as recited in claim 1, in which:
said pre-formed ceramic core form a ring and other interior spaces within said rocket engine injector, such as an injector manifold in an investment casting process.

5. A method as recited in claim 1, in which:
said pre-formed ceramic core is made by injection molding.

6. A method as recited in claim 1, in which:
said pre-formed ceramic core is made by an automated printing-like process directly from a CAD (Computer Aided Design) tool.

7. A method as recited in claim 1, in which:
said pre-formed ceramic core is removed from said casting using chemical means.

8. A method as recited in claim 7, in which:
removal of said pre-formed ceramic core by said chemical means is facilitated by thermal shock.

9. A method as recited in claim 7, in which:
removal of said pre-formed ceramic core by said chemical means is facilitated by mechanical vibration.

10. A method as recited in claim 7, in which:
removal of said pre-formed ceramic core by said chemical means is facilitated by mechanical drilling.

11. A method as recited in claim 1, in which:
said casting pattern is made from an investment casting wax.

12. A method as recited in claim 1, in which:
said casting pattern is made from a heat-disposable, resin-based composite.

13. A method as recited in claim 12, in which:
said casting pattern is made by stereolithography.

14. A method as recited in claim 1, comprising the additional step of:
manufacturing an injector face orifice (30) by mechanical drilling.

15. A method as recited in claim 1, comprising the additional step of:
manufacturing an injector face orifice (30) by laser drilling.

16. A method as recited in claim 1, comprising the additional step of:
manufacturing an injector face orifice (30) by Electrical Discharge Machining (EDM).

17. A method as recited in claim 1, in which:
abrasive flow machining is used to smooth and polish a propellant passage (18) and said injector orifice (30).
